(19) United States
(12) Patent Application Publication
(10) Pub. No.: US 2005/0283993 A1
(43) Pub. Date: Dec. 29, 2005

(54) Method and apparatus for fluid processing and drying a workpiece

(76) Inventors: Qunwei Wu, Westford, MA (US); Arthur Keigler, Wellesley, MA (US); Zhenqiu Liu, Northboro, MA (US); John Harrell, Paxton, MA (US); Steve Bowler, Tyngsboro, MA (US)

Correspondence Address: PROSKAUER ROSE LLP, ONE INTERNATIONAL PLACE 14TH FL, BOSTON, MA, 02110, US

(21) Appl. No.: 11/155,008

(22) Filed: Jun. 16, 2005

Related U.S. Application Data
(60) Provisional application No. 60/581,050, filed on Jun. 18, 2004.

(51) Int. Cl. B08B 3/00; B08B 3/12; F26B 3/00; F26B 21/06

(52) U.S. Cl. 34/443; 134/26; 134/34; 134/155; 134/184; 34/72

(57) ABSTRACT

A method and apparatus for fluid processing a workpiece are described. A gas can be used to agitate a fluid to improve cleaning and/or rinsing of a workpiece surface. The gas can reduce surface tension of the fluid to promote improved contact of the fluid with a surface of the workpiece. The surface of the workpiece can be dried by flowing gas along a portion of the workpiece surface during or after draining of the fluid.

### CROSS-REFERENCE TO RELATED APPLICATIONS

This application claims the benefits of and priority to U.S. Provisional Patent Application Ser. No. 60/581,050 filed on Jun. 18, 2004, which is owned by the assignee of the instant application and the disclosure of which is incorporated herein by reference in its entirety.

### FIELD OF THE INVENTION

The invention relates generally to a method and apparatus for fluid processing a workpiece, and more particularly to a method and apparatus for at least one of cleaning, rinsing and drying a workpiece during fluid processing.

### BACKGROUND OF THE INVENTION

Workpieces, such as semiconductor wafers, that have one or more surfaces that have been chemically or electrochemically treated, such as by electroplating or etching, can be rinsed and/or cleaned to remove residue or adhering substances from the workpiece prior to further processing. Various techniques can be used to rinse workpieces including cascade rinsing and quick dump rinsing. These techniques can be limited by the amount of fluid they consume, the relatively large platforms needed to perform a rinse, the length of time necessary to effect a through cleaning, and the cleanliness of the fluid after a rinse cycle. Furthermore, quick dump rinsing (QDR), which relies upon the rapid deployment of fluid from the rinse tank to remove water and impurities from the workpiece surface, in many instances does not adequately clean or remove contaminants from the surface. Therefore, in some instances, a QDR needs to be combined with a cascade rinse to properly remove chemicals or particles from the surface. If a workpiece is not adequately cleaned or rinsed, contaminants can remain that can cause defects in a workpiece or semiconductor device.

Another important feature of fluid processing is drying of a workpiece. An ideal drying process leaves few, if any, contaminants on a workpiece surface, and operates quickly and safely with little impact on the environment. Various technologies have been developed to control the drying process and reduce the level of contamination after a drying process. These drying processes can be limited by the need to heat a workpiece surface, heat the fluid, or heat a gas used to dry a workpiece. Heat can damage a workpiece surface and increase the expense and complexity of the equipment used.

Accordingly, a need has arisen in the art for an improved method and apparatus for fluid processing and drying a workpiece that substantially eliminates the deficiencies of prior techniques.

### SUMMARY OF THE INVENTION

The invention, in various aspects, features a system and components for processing one or more workpieces by application and removal of materials from one or more surfaces of the workpiece(s). The application and removal can be performed by fluid flow control and/or electric field control at a surface of a workpiece. A workpiece can be planar or substantially planar, can be thin or ultra-thin, or can be any combination thereof. Suitable workpieces include, but are not limited to, semiconductor wafers, silicon workpieces, interconnection substrates, and printed circuit boards. This field is sometimes referred to as fluid processing or wet processing, and includes electrodeposition, electroplating, electroless plating, chemical etching, resist coating, resist stripping, dielectric coating, and workpiece cleaning, among other processes.

In one embodiment, the invention features a method and apparatus for fluid processing a workpiece. For example, a gas can be used to agitate a fluid to improve cleaning and/or rinsing of a workpiece surface. The gas can reduce surface tension of the fluid to promote improved contact of the fluid with a surface of the workpiece. In one embodiment, the surface of the workpiece is dried by flowing gas along a portion of the workpiece surface during or after draining of the fluid.

In one aspect, the invention features a method of fluid processing a workpiece. The method includes providing the workpiece in a fluid disposed in a process module, and introducing a gas into the process module. The gas agitating the fluid to facilitate contact of the fluid with a contaminant on a surface of the workpiece.

In another aspect, the invention features an apparatus for fluid processing a workpiece. The apparatus includes a process module containing a fluid. The workpiece is retained by a workpiece holder disposed in the fluid. The apparatus also includes a gas distributor disposed in a lower portion of the process module. The gas distributor introduces a gas into the process module to agitate the fluid to facilitate contact of the fluid with a contaminant on a surface of the workpiece.

In still another aspect, the invention features an apparatus for fluid processing a workpiece. The apparatus includes means for providing the workpiece in a fluid contained by a process module, means for introducing a gas into the process module, and means for agitating the fluid with the gas to improve contact of the fluid with a contaminant on a surface of the workpiece.

In other examples, any of the aspects above or any apparatus or method described herein can include one or more of the following features. In one embodiment, the gas is introduced by flow through a micro-porous material. The gas distributor can be a micro-porous gas distributor. In one embodiment, the contaminant is removed from the surface of the workpiece. The gas or bubbles of a gas can reduce surface tension of the fluid. In some embodiments, the fluid, or at least a portion thereof, is removed from the process module, e.g., using a drain of the process module. Removal of the fluid can be done after the fluid is agitated. Fluid can be removed using a quick dump rinse. In some embodiments, the workpiece is dried. This can be done after the fluid has been removed from the process module. In one embodiment, the gas distributor flows gas along the surface of the workpiece as the drain removes fluid from the process module.

In yet another aspect, the invention features a method of fluid processing a workpiece. The method includes providing the workpiece in a fluid disposed in a process module and flowing a gas through a micro-porous material. The fluid is agitated in the process module with the gas to reduce surface tension of the fluid on a surface of the workpiece to facilitate contact of the fluid with a contaminant on the surface of the workpiece.

In still another aspect, the invention features an apparatus for fluid processing a workpiece. The apparatus includes a process module containing a fluid, and the workpiece is retained by a workpiece holder disposed in the fluid. The apparatus also includes a gas distributor comprising a micro-porous material disposed in a lower portion of the process module. The gas distributor introduces a gas into the process module to agitate the fluid to facilitate contact of the fluid with a contaminant on a surface of the workpiece.

In another aspect, the invention features a method of drying a workpiece. The method includes providing the workpiece in a fluid disposed in a process module and removing at least a portion of the fluid from the process module such that the fluid is removed from a surface of the workpiece. A flow of a room temperature gas is introduced along a portion of the surface of the workpiece to dry the surface.

In still another aspect, the invention features an apparatus for drying a workpiece. The apparatus includes a process module containing a fluid, and the workpiece is retained by a workpiece holder disposed in the fluid. The apparatus also includes a drain to remove at least a portion of the fluid from the process module to thereby remove the fluid from a surface of the workpiece, and a gas distributor disposed in a lower portion of the process module. The gas distributor introduces a room temperature gas that flows along a portion of the surface of the workpiece exposed by removing the fluid to dry said surface.

In yet another aspect, the invention features an apparatus for drying a workpiece. The method includes means for providing the workpiece in a fluid contained by a process module, means for draining the fluid from the process module to remove the fluid from a surface of the workpiece, and means for introducing a flow of a room temperature gas along a portion of a surface of the workpiece to dry said surface.

In one embodiment, the gas includes a laminar flow pattern. In various embodiments, the temperature of the gas can be between about 15° C. and about 25° C. The flow of the room temperature gas can accelerate the evaporation of fluid from at least the portion of the surface of the workpiece. In one embodiment, the gas distributor includes a micro-porous material.

Other aspects and advantages of the invention will become apparent from the following drawings, detailed description, and claims, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. In the drawings, like reference characters generally refer to the same parts throughout the different views. The drawings are not necessarily to scale, emphasis instead generally being placed upon illustrating the principles of the invention.

FIG. 1 depicts a block diagram of an exemplary production system for a workpiece.

FIG. 2 shows a perspective view of an illustrative embodiment of a workpiece holder.

FIG. 3 shows a perspective view of an illustrative embodiment of a process module according to the invention.

FIG. 4 depicts a perspective view of an illustrative embodiment of a gas distributor according to the invention.

FIG. 5 depicts a perspective view of another illustrative embodiment of a gas distributor according to the invention.

FIG. 6 shows an exemplary fluid agitation process according to the invention.

FIG. 7 depicts a sectional view of another exemplary process module according to the invention.

FIG. 8 shows a graphical view of an extractable test after processing a workpiece using various gas distributors.

### DESCRIPTION OF THE INVENTION

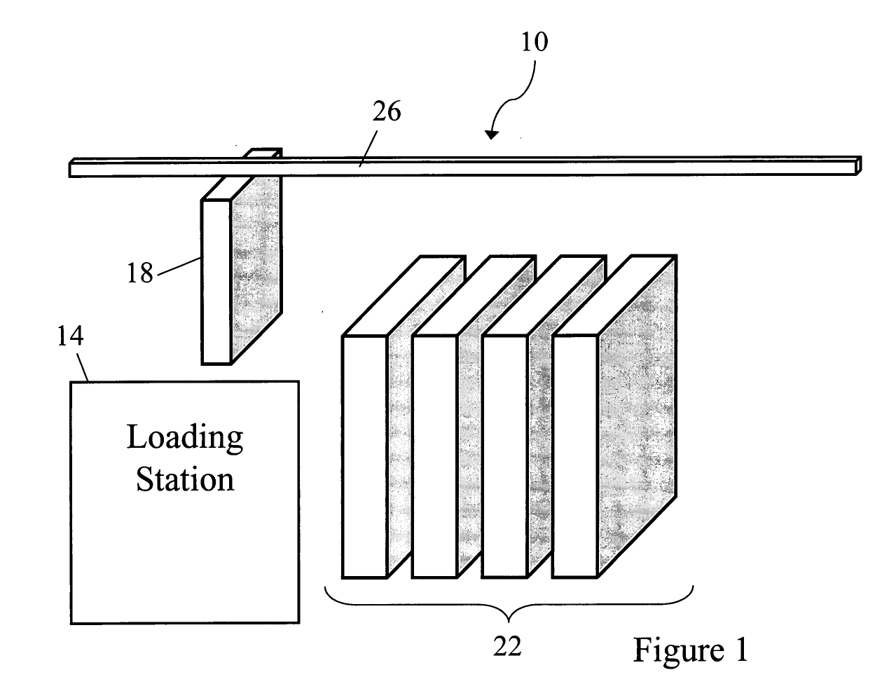

FIG. 1 illustrates an exemplary production system 10 for a workpiece. The production system 10 can utilize various features of the invention. The production system 10 can include a loading station 14 for delivering a workpiece to a workpiece holder 18. The production system 10 can also include one or more modules 22, e.g., process modules, for processing a workpiece. The loading station 14 and the one or more modules 22 can be mounted in a single framework, or in adjacent frameworks. The framework can include a transport system 26 for moving a workpiece holder 18 from the loading station 14 to a first module and between modules. An exemplary production system is a Stratus System available from NEXX Systems, Inc. in Billerica, Mass.

The workpiece can be planar, substantially planar, and/or thin or ultra-thin, or any combination thereof. In various embodiments, the workpiece has a circular shape or a substantially circular shape. In other embodiments, the workpiece is non-circular. For example, the workpiece can be rectangular, square, oval, or triangular, or have another suitable geometric configuration. In various embodiments, the workpiece can be, for example, a semiconductor wafer, a silicon workpiece, an interconnection substrate, a printed circuit board, or another workpiece suitable for processing. The loading station 14 can be an automated loading station, such as an automated wafer handling front end available from Newport Automation in Irvine, Calif. or Brooks Automation in Chelmsford, Mass.

The workpiece holder 18 can be used to retain a single workpiece, or a plurality of workpieces. The workpiece holder 18 can utilize a back-to-back configuration for two or more workpieces. Furthermore, the workpiece holder 18 can have a hole bored through its center for processing a plurality of surfaces of a single workpiece.

Each of the one or more modules 22 can be used for one or more of cleaning, rinsing, drying, pretreating, plating, buffering/holding, etching, electrodepositing, electroplating, electroetching, electrodissolution, electroless depositing, electroless dissolution, photoresist depositing, photoresist stripping, chemical etch processing, seed layer etching, metal etching processing, and similar processes requiring fluid flow and/or electric field control and use. In various embodiments, the workpiece is retained by the workpiece holder 18 while processing is performed. Each of the one or more modules 22 and/or the workpiece holder 18 can be used to apply a variety of films to a surface of a workpiece, including, but not limited to, metal, plastic, and polymer films. Suitable metals include, but are not limited to, copper, gold, lead, tin, nickel, and iron. In addition, alloys, compounds, and solders of these metals (e.g., lead/tin and nickeViron) can be applied to a workpiece surface.

In various embodiments, the film deposited can have a thickness between about 1 μm and about 150 μm. Using the features of the invention, the film can be high purity, and the thickness can be uniform across the surface of the workpiece. The film can have uniform electrical properties on (i) a flat, continuous uniform surface, (ii) on a flat continuous surface with micro-scale topography, and/or (iii) on a flat surface with topography and/or photo-resist patterning.

In various embodiments, the production system 10 can include between one and thirty modules, although additional modules can be used depending on the application. Various novel features of the one or more modules 22 are described in more detail below. Each of the one or more modules 22 can include a robust and modular construction so that it can be removed from the production system 10. As such, the production system 10 can be customizable for specific applications. For example, a module and a workpiece holder can be configurable for processing different sized workpieces, e.g., 100, 150, 200, 250 or 300 mm wafers, with minimal lost production time during customization.

In addition, the layout of a processing system, e.g., the position or sequence of one or more process modules, can be optimized for a specific fluid process or for a series of processes, which can lead to increased throughput. For example, a vertical line architecture, e.g., as utilized by the Stratus System, can be combined with a dual wafer processing system. An exemplary production rate is about 40 workpieces per hour.

Furthermore, the layout of a processing system can orient a workpiece in a vertical configuration. For a process or series of processes having a long deposition time, a vertical configuration can enable a significant number of workpieces to be processed simultaneously. For example, for a process time longer than about 10 minutes, over 20 workpieces can be processed simultaneously. In addition, in a process that generates substantial volumes of gas or air at the workpiece surface, e.g., electrophoretic deposition of photoresist, a vertical configuration can facilitate the removal of air or gas bubbles from the surface of a workpiece.

The production system 10 itself can be manual or automated. The production system 10 can include a computer that controls the operation of the loading station 14 and/or the transport system 26, as well the one or more modules 22. In one exemplary embodiment of an automated system, a freshly loaded workpiece is transported from the loading station 14 to the most distant module, and then subsequent processing returns the finished workpiece to the loading station 14.

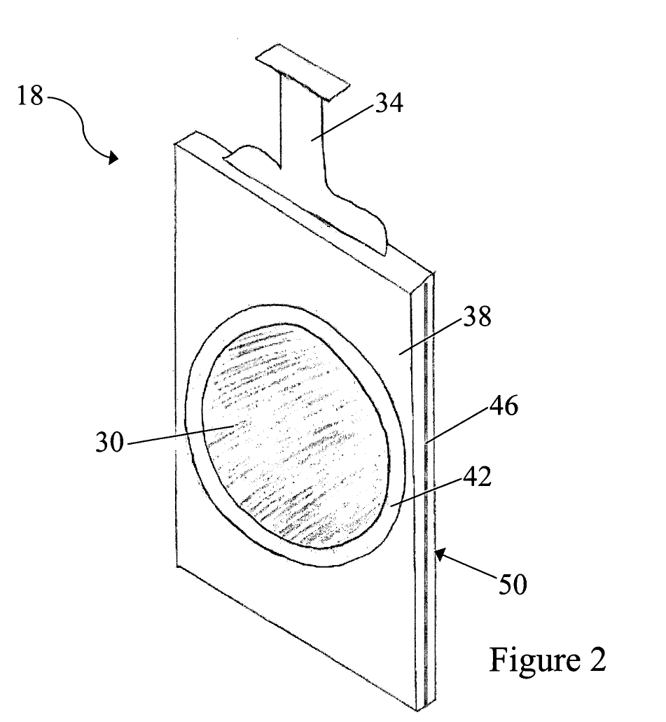

FIG. 2 shows an illustrative embodiment of a workpiece holder 18 for retaining a workpiece 30. In this illustrative embodiment, the workpiece holder 18 includes a handle 34 that can be used to lift and/or transport the workpiece holder 18. The handle can be engageable with the transport mechanism 26 shown in FIG. 1. The workpiece holder 18 also includes a body 38 and a ring 42 for contacting the workpiece 30. In various embodiments, the body 38 of the workpiece holder 18 is formed from a plastic, such as high density polyethylene (HDPE) or polyvinylidene fluoride (PVDF). The body 38 can also include a guide strip 46 formed in at least one edge 50. The guide strip(s) 46 can be used to align the workpiece holder 18 in one of the modules 22.

The ring 42 can press, hold, and/or retain the workpiece 30 against the body 38 of the workpiece holder. Contact between the workpiece 30 and the ring 42 occurs at the outer perimeter of the workpiece 30, e.g., by contacting less than 2 mm of the outer perimeter of the workpiece 30. In various embodiments, the ring 42 includes a flexible member encased in an elastomer. Portion(s) of the elastomer can be used to contact the workpiece 30, and, in some embodiments, can create a seal with the workpiece 30.

In various embodiments, the ring 42 can have a circular shape, a substantially circular shape, or be non-circular (e.g., rectangular, square, oval, or triangular, or have another suitable geometric configuration). In one embodiment, the ring 42 has a low profile relative to the workpiece 30. For example, in one detailed embodiment, the ring 42 extends less than about 1 mm beyond the plane of the exposed surface of the workpiece 30. In various embodiments, the ring 42 can be a contact ring or a sealing ring. In one embodiment, the ring 42 is the sealing ring assembly described in U.S. Pat. No. 6,540,899 to Keigler, the entire disclosure of which is herein incorporated by reference. In some embodiments, a member, e.g., formed from a spring-like material, such as stainless steel or titanium, can be used to engage the ring and apply a force to the ring to cause the ring to form a barrier to fluid entry with at least the workpiece. The member can include at least one retaining feature that can engage at least one engagement feature of the ring. In various embodiments, the ring 42 and the member are removably attached to the workpiece holder 18. Various workpiece, ring and member configurations, as well as process module configuration, are described in U.S. Patent Application Publication No. 2005/0089645 by Keigler et al., the entire disclosure of which is herein incorporated by reference.

In one embodiment, the workpiece holder 18 can include pneumatic and electrical ports attached at the top of the body. One or more ports can be used to communicate pressure, vacuum, or electrical current, as required, to control the ring 42 and/or member of the workpiece holder 18.

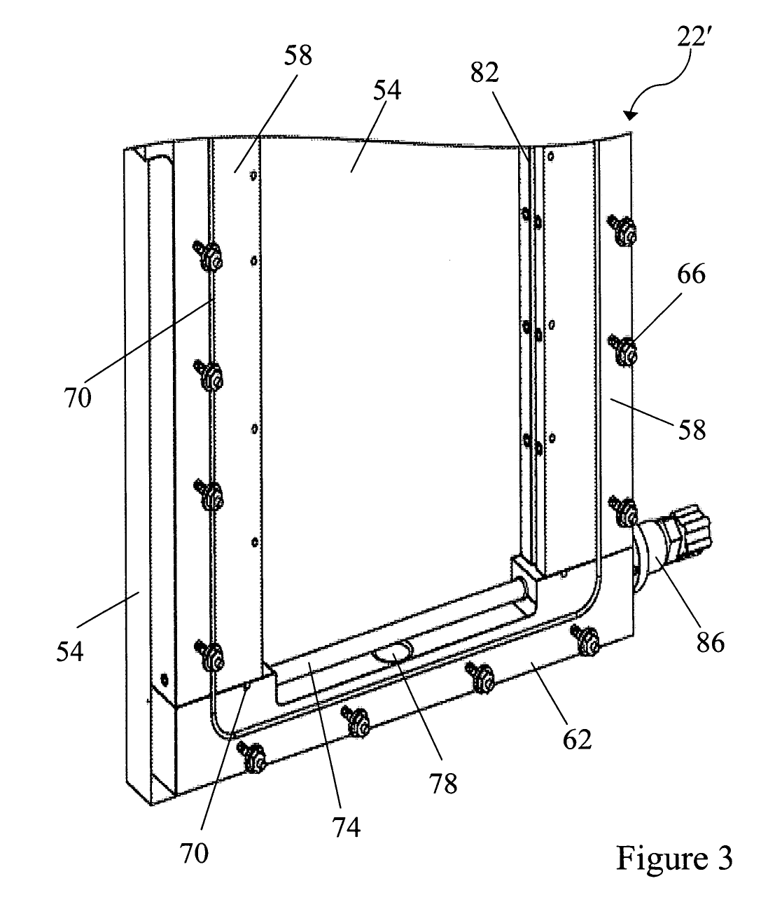

FIG. 3 depicts a portion of an exemplary process module 22′, which can be used for fluid processing a workpiece 30. The process module 22′ can be used to rinse and/or clean the workpiece 30. In one embodiment, the process module 22′ is used to dry the workpiece 30. In various embodiments, a process module, such as process module 22′, can feature high throughput, minimal use of a cleaning solution, and a small foot print, while demonstrating substantially no mechanical movement of the workpiece 18.

As illustrated, the process module 22′ includes an end wall 54, side walls 58, and a floor 62. The process module 22′ is shown without a front wall, which in some embodiments can be an anode or cathode. The walls and floor of the process module 22′ can be fastened using screws, such as the screws 66 shown in FIG. 3, or using other suitable fasteners. A sealing member 70 can be used, for example, between walls 58 or between a wall 58 and the floor 62. The sealing member 70 can be an o-ring or other elastomer member suitable for forming a fluid seal between two components.

The process module 22′ also includes a gas distributor 74 for emitting a gas into the process module 22′. The gas can be in the form of gas bubbles in a fluid, e.g., deionized water, a chemical plating bath, or an electroplating bath. The gas distributors 74 can include a plurality of spaced holes for emitting bubbles of a gas into the fluid. The gas or the gas bubbles can agitate the fluid in the process module 22′. This can improve contact between fluid and a contaminant on a surface of the workpiece 30, which can improve cleaning of the workpiece 30. This is described in more detail below.

The process module 22′ can also include an inlet/drain 78 for introducing a fluid into the process module 22′ and/or for removing fluid from the process module 22′. A side wall 58 can include a groove 82 for receiving a guide strip 46 of a workpiece holder 18, and connection 86 can be used to direct gas from a source (not shown) to the gas distributor 74. Although not depicted in FIG. 3, the process module 22′ can include one or more of a quick dump valve, a slow drain valve, a fluid inlet, or a conductivity probe for sensing metal impurities.

The gas distributor 74 can be attached at one or more points in the process module 22′. As illustrated in FIG. 3, the gas distributor 74 is attached to the floor 62 of the process module 22′ at two positions. Each end of the gas distributor 74 can be connected using a fitting (e.g., a polyvinyl chloride (PVC) end fitting, a pipe thread fitting, or a Swagelock fitting), an adhesive, a sealant, an epoxy, a cement, or other suitable affixation means known in the art. In some embodiments, each end of the gas distributor 74 is connected to a side wall 58 of the process module 22′. In some embodiments, a first end of the gas distributor 74 is connected to a side wall 58 of the process module 22′, and a second end is connected to the floor 62. In various embodiments, a first end of the gas distributor 74 is connected to either a side wall 58 or the floor 62, and a second end—the unconnected end—can be capped or solid to preclude gas from escaping through that end.

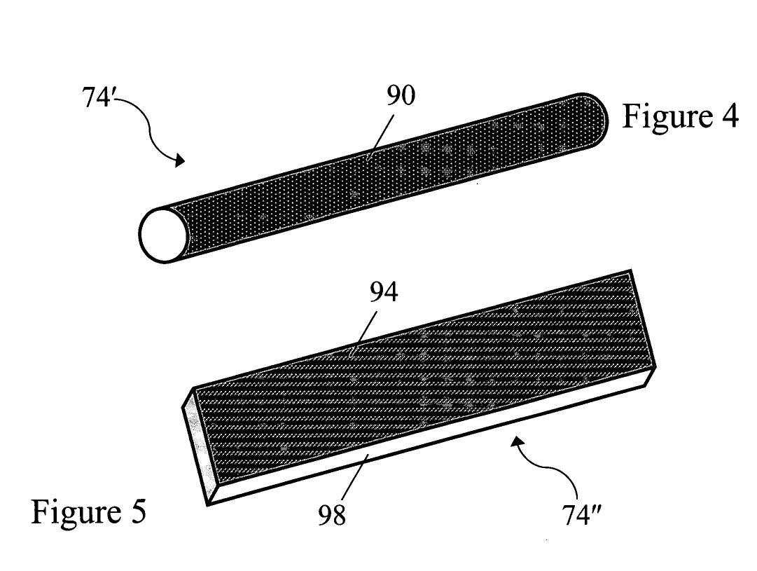

In various embodiments, the gas distributor 74 can have a tube-like shape or a plate-like shape. FIG. 4 shows an exemplary gas distributor 74′ having a tube shape. The holes are shown as small circles on a surface 90 of the gas distributor 74′, although the holes need not be this shape. FIG. 5 shows an exemplary gas distributor 74″ having a plate-like shape. The holes are shown as channels on a top surface 94 of the gas distributor 74″, although the holes need not be this shape. Although not shown, one or more side surfaces 98 can include holes as well. In various embodiments, the holes are uniformly distributed, substantially uniformly distributed, or randomly distributed on a surface of a gas distributor 74, 74′, or 74″ (collectively 74x). Either gas distributor 74′ or 74″ can be adapted for use in the process module 22′.

In one embodiment, a gas distributor 74x can be made of a micro-porous material. The micro-porous material can have a range of pore sizes, or can have a uniform pore size. The hole size can be fine, medium or course. For example, suitable pore sizes include between about 1 μm to about 500 μm, although larger and smaller pore sizes can be used depending on the embodiment. In one detailed embodiment, the pores are substantially uniform and can be about 20 μm. In various embodiments, the micro-porous material can be polyethylene, HDPE, PVC, polypropylene, polysulfone, polyether sulfone, polytetrafluoroethylene (PTFE), nylon, PVDF, ceramic, or metal. In one detailed embodiment, the micro-porous material can be a polyethylene porous tubing (e.g., a porous tubing available from Porex Porous Products Group, Fairburn, Ga.). Suitable gases for emission into the fluid include, but are not limited to, nitrogen or an inert gas such as helium, neon, or argon.

As described above, the process module 22′ including a gas distributor 74x can be used for cleaning and/or rinsing a workpiece 30. In one embodiment, the workpiece 30 retained by a workpiece holder 18 is disposed in the process module 22. The fluid (e.g., deionized water) can be introduced into the process module 22′ using the inlet/drain 78. For example, a fluid inlet valve introduces the fluid. In another embodiment, the process module 22′ contains the fluid, and the workpiece holder 18 retaining the workpiece 30 is immersed in the fluid.

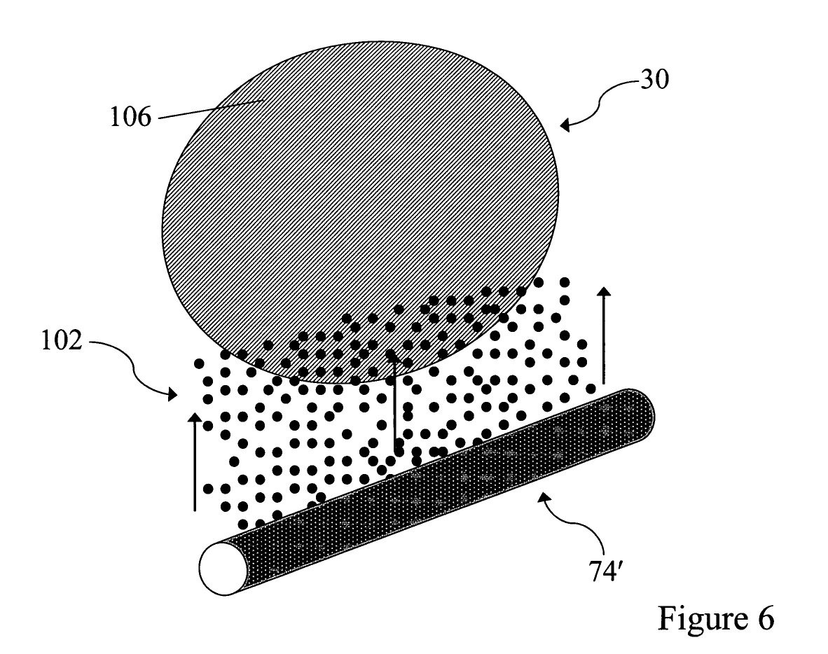

FIG. 6 depicts the gas distributor 74′ emitting gas 102 into the fluid. The gas 102, in the form of bubbles, generally rises (here, the direction is shown by arrows) and interacts with a surface 106 of the workpiece 30. The gas 102 can be uniformly distributed, substantially uniformly distributed, or randomly distributed in the fluid by the gas distributor 74′. The flow rate through the gas distributor 74′ can be between about 1 cubic foot per hour and about 1,000 cubic feet per hour, although the flow rate can be larger or smaller depending on the embodiment. In various embodiments, the flow rate can be between about 10 cubic feet per hour and about 50 cubic feet per hour. In one detailed embodiment, the flow rate is about 25 cubic feet per hour.

In one embodiment, the gas 102 agitates the fluid, which can reduce the surface tension of the fluid and can improve mixing of the fluid. This can improve the surface contact of the fluid to the surface 106 of the workpiece 30. As such, the fluid can contact or substantially completely contact the surface 106. One advantage of this is more efficient removal of a contaminant from the surface 106. Accordingly, this technique can reduce the level of particle contaminants or chemical residue remaining on the surface 106 of the workpiece 30 or remaining in the fluid used to clean or rinse the workpiece 30. Contaminants include, but are not limited to, loose particles, particulates, chemicals, chemical residues, or an unwanted species in the process module.

In one embodiment, the gas is introduced using a micro-porous material. A micro-porous gas distributor can be sued to emit the gas. In one embodiment, the surface 106 and a second surface (not shown) of the workpiece 30 are cleaned and/or rinsed. In one embodiment, the surface 106 of the workpiece 30 and at least one surface of a second workpiece (not shown) are cleaned and/or rinsed.

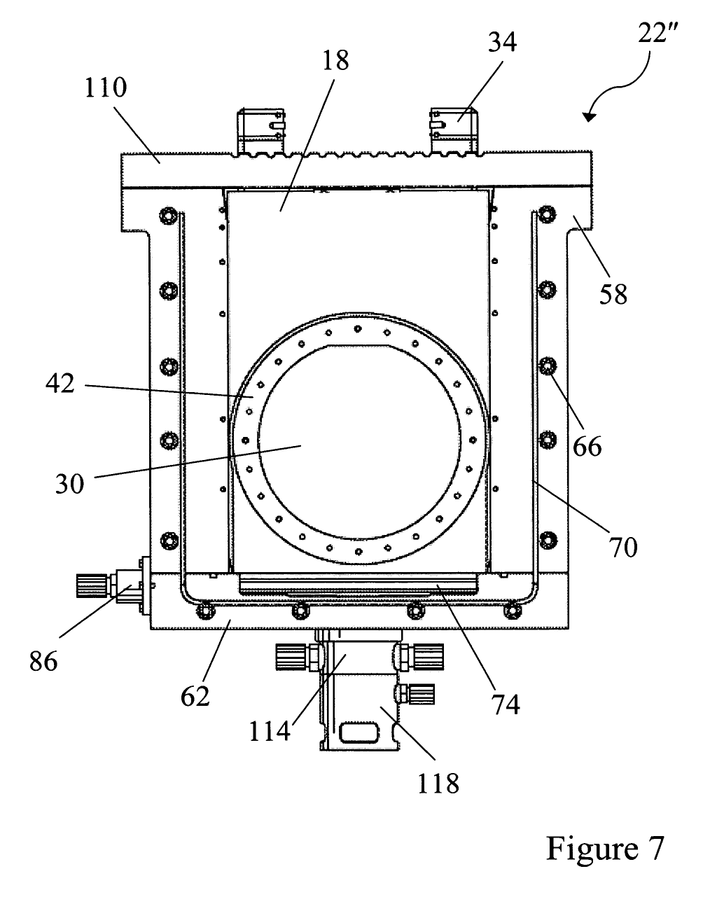

During or after agitation, the fluid, or at least a portion thereof, can be removed from a process module. For example, a quick dump rinse or a slow drain can be performed. FIG. 7 shows an illustrative embodiment of a process module 22″ including additional features not shown in FIG. 3. The process module 22″ can be used for rinsing and/or cleaning the workpiece 30, as described above. The process module 22″ includes a cover 110 disposed on the side walls 58 and is shown with a workpiece holder 18 disposed in the process module 22″. The workpiece holder 18 includes a ring 42 retaining a workpiece 30 and a handle 34.

In the illustrate embodiment, the process module 22″ includes a fluid inlet and conductivity probe 114 attached to the drain of the floor 62. A quick-dump valve 118 can also be attached directly to the process module 22″ or to the fluid inlet and conductivity probe 114. In one embodiment, the fluid inlet and the conductivity probe 114 are separate pieces. In various embodiments, the fluid inlet is used to fill the process module 22″ with a fluid, e.g., deionized water. In one embodiment, the quick-dump valve 118 can be quick-dump valve model number QD-104520-pol-VT-001 available from BECO Manufacturing Co. (Laguna Hills, Calif.). In one embodiment, the conductivity probe 114 can be a 200CR series system conductivity meter and probe available from Mettler-Toledo Thornton, Inc. (Bedford, Mass.).

A quick dump rinse relies upon the rapid deployment of fluid from the process module 22′ or 22″ to remove the fluid and to remove any contaminants which can be in the process module 22′ or 22″ or on a surface of the workpiece 30. During the rinsing process, the conductivity probe 114 can be used to make a conductivity measurement to determine the cleanliness of the fluid. If the fluid still includes impurities, or of the impurity level is above a threshold value, the rinsing process can be run for one ore more additional cycles. The rinsing process can be followed by a drying process.

In one embodiment, the drying process includes a draining process. The draining process effectively “peels off” fluid from a surface of the workpiece 30. In one embodiment, the fluid is drained slowly from a process module so that mechanical strain within the fluid is low enough that viscosity of the fluid holds it together. This can preclude ripping the fluid separating into droplets the “peeling” off occurs as a result of surface tension of the fluid. In various embodiments, a fluid can be drained using the drain/inlet 78 shown in FIG. 3 or the fluid inlet and conductivity probe 114 and/or the quick-dump valve 118 shown in FIG. 7. In one embodiment, a slow drain valve is used.

The fluid need not be drained from the bottom of the process module 22′ or 22″, as other positions for a drain such as on a front wall, side wall, or back wall can be used. In addition, the process 22′ or 22″ need not be emptied completely or the fluid removed completely. In some embodiments, only a portion of the fluid is removed. For example, the fluid can be drained to a level such that only a portion of the workpiece 30 and/or ring 42 are exposed. In another embodiments, the fluid is drained to a level such that the entire workpiece 30 and/or ring 42 are exposed, and fluid remains in the process module. In some embodiments, the fluid can be deionized water, which reduces harmful emissions as hazards chemicals (e.g., organic chemicals or volatile organic chemicals) are not used in the drying process.

In one embodiment of the drying process, the workpiece 30 is immersed in a fluid in the process module 22′ or 22″. The fluid, or at least a portion thereof, is drained from the process module 22′ or 22″ using a slow drain valve. The velocity of fluid surface dropping can be between about 0.1 mm/min and about 200 mm/min, although the value can be larger or smaller depending on the embodiment. In one embodiment, the gradual draining of the fluid substantially completely removes the fluid droplets from the workpiece. This can be a result of draining slowly so that the mechanical strain within the fluid is low enough so that the viscosity of the fluid can hold the fluid together.

As the fluid is being drained or after the fluid is drained, the workpiece 30 can be dried. In various embodiments, drying can be performed with a heating element, such as a lamp or resistive heater, or by evaporative drying, such as using solvent or flowing as gas. Referring to FIG. 3 or FIG. 7, in one embodiment, a gas can be distributed from the gas distributor 74x to further dry the workpiece. The temperature of the gas can be between 10° C. and about 120° C., although the temperature can be higher or lower depending on the embodiment. In various embodiments, the temperature of the gas can be between 15° C. and about 25° C. In one detailed embodiment, the temperature is room temperature or substantially room temperature. Measurements have shown that heating the gas to 80° C. only reduces the drying time by about 30 seconds, which is arguably not a significant savings of time to warrant the extra expense.

In some embodiments, the gas distributor 74x can uniformly distribute gas along a portion of the workpiece 30, e.g., across the surface 106 of the workpiece 30. In one embodiment, the gas is flowed between the workpiece 30 and the workpiece holder 18. The flow of the gas can have a laminar flow type pattern, which can minimize streaking and water spotting on the workpiece 30. In some embodiments, during or after a drain process, a thin layer of fluid can remain on the surface of the workpiece 30. This fluid can be removed by evaporation, which can accelerate the drying process. A low fluid vapor pressure can be maintained over the thin layer by flowing the gas. This continuously dilutes the local fluid vapor concentration at the thin layer.

In some embodiments, a turbulent flow pattern can be used. The flow rate through the gas distributor 74′ can be between about 1 cubic foot per hour and about 1,000 cubic feet per hour, although the flow rate can be larger or smaller depending on the embodiment. In various embodiments, the flow rate can be between about 120 cubic feet per hour and about 800 cubic feet per hour. In one detailed embodiment, the flow rate is about 300 cubic feet per hour.

A technical advantage of the present technology includes providing a more efficient process module to clean and rinse workpieces. The process module can form micro-bubbles of a gas to maximize the fluid to workpiece contact, which can increase the overall efficiency of a rinse cycle. In addition, using a process module that conforms to the shape of an associated workpiece holder can permit use of a smaller process module. This can result in less fluid being consumed during a rinse, drain, or dry cycle, which can decrease the cost of building, maintaining, and using the equipment.

Furthermore, by increasing the efficiency and decreasing the overall size of the process module, the cleaning and/or rinsing processes can be performed in less time than prior art methods. For example, three rinsing and cleaning cycles can be performed in about 30 to 45 seconds. In one embodiment, two 200 mm silicon wafers can be processed in a footprint of about 180 mm by 400 mm. The throughput achievable can be about 90 to 120 wafers per hours. Multiple rinse and dry tanks can be linked together without requiring excessive floor space because the process module width is only about 180 mm. Therefore, two wafers can be processed simultaneously.

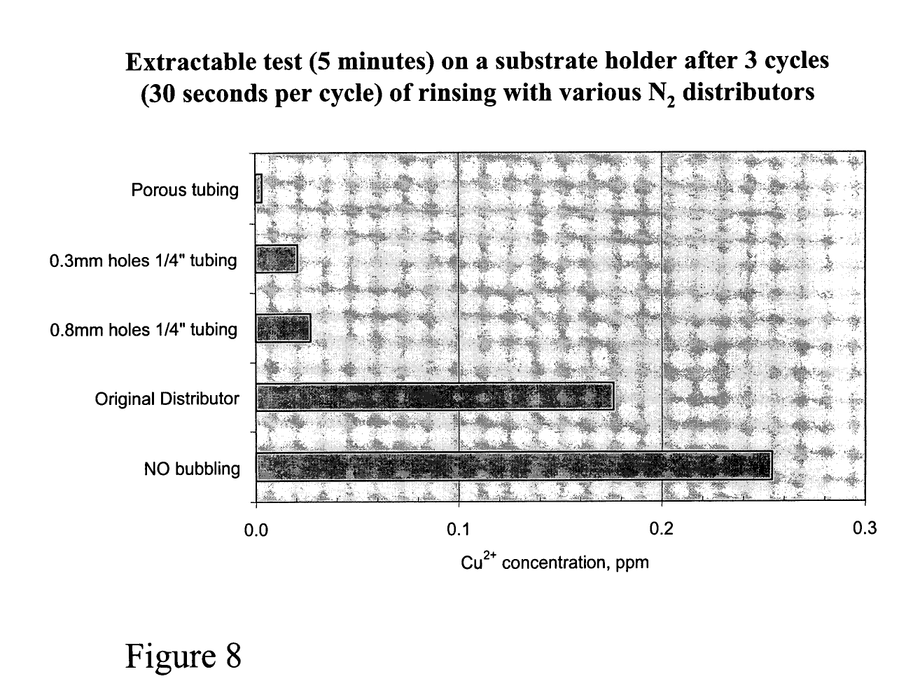

FIG. 8 shows a graph of an extractable test, which was run for five minutes, on a workpiece holder after three cycle rinses with various gas distributors. The test sample was a workpiece holder retaining two workpieces. The workpiece holder was immersed into a copper plating solution (CUBATH available from Enthone, Inc., West Haven, Conn.) for five minutes, then removed from the solution and held for five seconds before placing the workpiece holder into a rinse/dry apparatus, such as the one described above. Nitrogen was bubbled through the rinse/dry apparatus with various gas distribution systems for three cycles of for thirty seconds each. The extractable measurement was then performed by monitoring the conductivity of the solution. As can be seen in FIG. 10, a micro-porous gas distributor, as described above, exhibits the lowest extract level. This is the case even with a five second cycle time instead of thirty second cycle times. The extractable Cu²⁺ concentration was about 0.035 ppm after three rinsing cycles of five seconds for the micro-porous gas distributor.

While the technology has been particularly shown and described with reference to specific illustrative embodiments, it should be understood that various changes in form and detail may be made without departing from the spirit and scope of the technology as defined by the appended claims.

1. A method of fluid processing a workpiece, comprising:
providing the workpiece in a fluid disposed in a process module; and
agitating the fluid in the process module with a gas to facilitate contact of the fluid with a contaminant on a surface of the workpiece.

2. The method of claim 1 further comprising flowing the gas through a micro-porous material to introduce the gas to the process module.

3. The method of claim 1 further comprising removing the contaminant from the surface of the workpiece.

4. The method of claim 1 wherein bubbles of gas agitate the fluid to reduce surface tension of the fluid.

5. The method of claim 1 further comprising removing a portion of the fluid from the process module.

6. The method of claim 1 further comprising performing a quick dump rinse to remove a portion of the fluid from the process module.

7. The method of claim 1 further comprising drying the workpiece.

8. An apparatus for fluid processing a workpiece, comprising:
a process module containing a fluid, the workpiece retained by a workpiece holder disposed in the fluid; and
a gas distributor disposed in a lower portion of the process module, the gas distributor introducing a gas into the process module to agitate the fluid to facilitate contact of the fluid with a contaminant on a surface of the workpiece.

9. The apparatus of claim 8 wherein the gas distributor comprises a micro-porous material.

10. The apparatus of claim 8 wherein the process module comprises a drain to remove a portion of the fluid from the process module.

11. The apparatus of claim 10 wherein the gas distributor flows gas along the surface of the workpiece as the portion of the fluid is removed from the process module.

12. A method of fluid processing a workpiece, comprising:
providing the workpiece in a fluid disposed in a process module;
flowing a gas through a micro-porous material; and
agitating the fluid in the process module with the gas to reduce surface tension of the fluid on a surface of the workpiece to facilitate contact of the fluid with a contaminant on the surface of the workpiece.

13. An apparatus for fluid processing a workpiece, comprising:
a process module containing a fluid, the workpiece retained by a workpiece holder disposed in the fluid; and
a gas distributor comprising a micro-porous material disposed in a lower portion of the process module, the gas distributor introducing a gas into the process module to agitate the fluid to facilitate contact of the fluid with a contaminant on a surface of the workpiece.

14. A method of drying a workpiece, comprising:
providing the workpiece in a fluid disposed in a process module;
removing at least a portion of the fluid from the process module such that the fluid is removed from a surface of the workpiece; and
introducing a flow of a room temperature gas along a portion of the surface of the workpiece to dry said surface.

15. The method of claim 14 wherein the gas includes a laminar flow pattern.

16. The method of claim 14 wherein the flow of the room temperature gas accelerates the evaporation of fluid from at least the portion of the surface of the workpiece.

17. The method of claim 14 wherein the temperature of the gas is between about 15° C. and about 25° C.

18. An apparatus for drying a workpiece, comprising:
a process module containing a fluid, the workpiece retained by a workpiece holder disposed in the fluid;
a drain to remove at least a portion of the fluid from the process module to thereby remove the fluid from a surface of the workpiece; and
a gas distributor disposed in a lower portion of the process module, the gas distributor introducing a room temperature gas that flows along a portion of the surface of the workpiece exposed by removing the fluid to dry said surface.

19. The apparatus of claim 18 wherein the gas distributor comprises a micro-porous material.

20. The apparatus of claim 18 wherein the gas includes a laminar flow pattern.

21. The apparatus of claim 18 wherein the flow of the room temperature gas accelerates the evaporation of fluid from at least the portion of the surface of the workpiece.
